(19) United States
(12) Patent Application Publication
(10) Pub. No.: US 2009/0094202 A1
(43) Pub. Date: Apr. 9, 2009

(54) ITEM LOCATION FINDER

(76) Inventors: Kelly Aymar, Poughkeepsie, NY (US); Tamer E. Abuelsaad, Pougheepsie, NY (US)

Correspondence Address: IBM CORP (YA);C/O YEE & ASSOCIATES PC, P.O. BOX 802333, DALLAS, TX, 75380, US

(21) Appl. No.: 11/869,174

(22) Filed: Oct. 9, 2007

(51) Int. Cl. G06F 17/30

(52) U.S. Cl. 707/3; 707/E17.135

(57) ABSTRACT

Illustrative embodiments provide a computer implemented method, a data processing system and a computer program product for locating items. In one illustrative embodiment, the computer implemented method comprises receiving a request for a location of an item from a requester, sending a query to a repository containing information relating to the location of the item, and obtaining a result from sending the query, wherein the result comprises, a location identifier if the location of the item was found in the repository. The result is then returned to the requester.

### BACKGROUND OF THE INVENTION

1. Field of the Invention

The present invention relates generally to item locality of reference and more particularly to a computer implemented method, data processing system and computer program product for locating items

2. Description of the Related Art

Everyday life typically involves a quest for an item of one sort or another. A common scenario involves the entering of a store or office building to seek out an item of interest. In many cases, the location of the item of interest is not readily evident and one has to search. Various aids have been provided from directories, as in the form of posters in a shopping mall to information assistants who respond to queries by providing directions. An item is not limited to a physical thing, but it can be a person. For example, rather than looking for an article of merchandise to purchase in store, an item may be a person. If the person worked within a large company office complex, locating that person without specific directions may prove to be fruitless. You may have a name and phone number to identify the individual, but that alone may not be helpful when the location is desired. In many cases, one is left with the choice of calling the person and asking for directions, and if the directions include more than a few steps, having to record the directions.

### SUMMARY OF THE INVENTION

Illustrative embodiments provide a computer implemented method, a data processing system and a computer program product for locating items.

The computer implemented method comprising receiving a request for a location of an item from a requester, sending a query to a repository containing information relating to the location of the item, obtaining a result from sending the query, wherein the result comprises, a location identifier, if the location of the item was found, and returning the result to the requester.

The data processing system comprising, a bus, a storage device connected to the bus, a communications unit connected to the bus, a processing unit connected to the bus, a receiver capable of receiving a request for a location of an item from a requester, a generator capable of sending a query to a repository containing information relating to the location of the item, an extractor capable of obtaining a result from sending the query wherein, the result comprises, a location identifier, if the location of the item was found in the repository, and a notifier capable of returning the result to the requester.

The computer program product comprising a computer usable recordable type medium having computer usable program code embodied therein, the computer usable program code comprising, computer usable program code for receiving a request for a location of an item, computer usable program code for sending a query to a repository containing information relating to the location of the item, computer usable program code for obtaining a result from sending the query, wherein the result comprises a location identifier, if the location of the item was found in the repository, and computer usable program code for returning the result to the requester.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system of FIG. 1, in which illustrative embodiments may be implemented;

FIG. 3 is a block diagram of a data processing system of FIG. 1, including software components in accordance with illustrative embodiments;

FIG. 4 is a pictorial diagram of a client of FIG. 1 in accordance with illustrative embodiments;

FIG. 5 a block diagram of the client of FIG. 4, in accordance with illustrative embodiments;

FIG. 6 is a tabular diagram of a simple look-up table in accordance with illustrative embodiments;

FIG. 7 is a flowchart of a message based request for an item location process in accordance with illustrative embodiments; and

FIG. 8 is a flowchart of a web based request for an item location process in accordance with illustrative embodiments.

### DETAILED DESCRIPTION OF THE PREFERRED EMBODIMENT

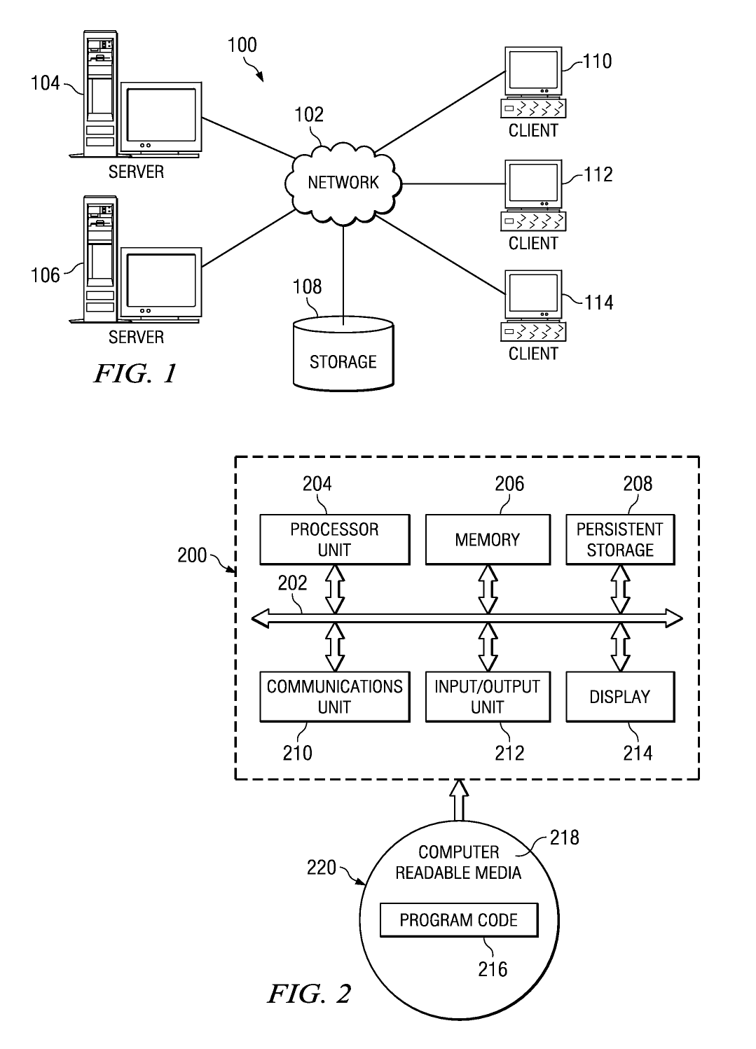

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In another example, server 104 may contain location and descriptive information for items carried in a retail store. Client 110 may be a kiosk that allows customers to query the product information related to items carried in the store where the kiosk is located. Item information may describe the item and the location within the retail where a customer may find the specific item. A requester may also take the form of a device rather than a user. For example, a client 110 may be programmed to produce a location listing of promotional items that are featured in a retail store as an aid to shoppers.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

Illustrative embodiments provide services for receiving a request, typically from a user, for the location of the item, and then creating a query for a repository that contains information regarding the location of the item and other items. A result is obtained, from the query, including, a location identifier for each item located, otherwise an indication of not found. The result is then returned to the requester in response to the initial request.

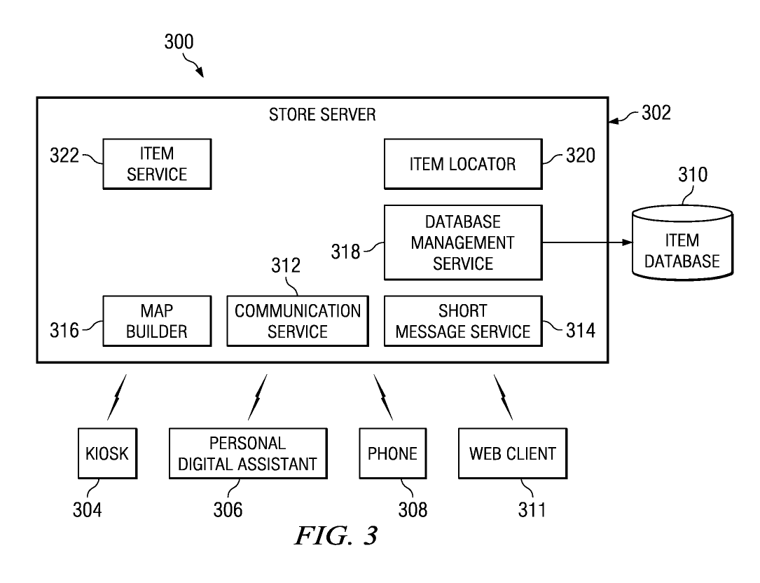

With reference to FIG. 3, a block diagram of a data processing system of FIG. 1 including software components in accordance with illustrative embodiments is shown. Store server 302 may be an instance of server 104 while kiosk 304, personal digital assistant 306, and phone 308 may be representative of clients 110, 112 and 114 respectively of FIG. 1. Further, item database 310 may be viewed as a specific instance of storage 108 of FIG. 1.

Item database 310 contains information regarding the items of interest. An item of interest is not limited to a physical thing residing on a shelf awaiting purchase. An item may also be a person with whom one desires to meet. Characteristics of the database enable the searching and retrieval of information by a plurality of keys. Data in the database may be referenced by many methods including use of primary and alternate keys. Typically a search of the database would be based on the item number for a stock item, the name of a person, perhaps an employee identifier or even a description. The format of the data and the means by which the item is selected is of no particular concern; however, a particular implementation must be aware of the content format to enable an efficient search of the material.

Kiosk 304 may be connected directly by wire or indirectly as in the case of wireless connection to store server 302. Personal digital assistant 306 and phone 308 are presumed to be connected indirectly by wireless connections. The location of a user of kiosk 304 is known because a user has to physically interact with kiosk 304 in order to transact, whereas the locations of users of personal digital assistant 306 and phone 308 are not. A user of kiosk 304 has to personally remember information or write the information presented by kiosk 304, or use a print service of kiosk 304 if provided. Personal digital assistant 306 and phone 308 in contrast allow information to be transmitted to the respective device.

Store server 302 includes support services and functions to enable the locating of items of interest by a plurality of users. Services typically include an operating system, as well as a number of services including communication service 312, short message service (SMS) 314, map builder 316, database management system 318 and item locator 320.

Communication service 312 functions as a communication unit to provide the transport mechanism and interfaces to serve a variety of specific protocols including wireless and web based protocols for communication with the client devices.

Short message service 314 provides a text based messaging service to allow easy access to send and receive textual data wherein the message is typically very brief. Text message support allows remote and mobile access from a variety of devices in a device independent format to and from store server 302.

Map builder 316 provides a capability to generate graphic content in the form of maps. For example, a request for an item location may be responded to with a pictorial representation of the location. If a requester location is presumed the response may also include a route to the item location from the requester location. In another example, if a set of items was requested, a map may be returned including a traversal path to obtain the items.

Database management service 318 provides the management and interfaces for persistent storage, such as item database 310. Database management service 318 manages the storage space allocated for the database information and provides essential services to create, delete, and modify the information content. Item locator 320 is a component of database management service 318 providing the search and retrieval facility to extract item related information from item database 310. Item locator 320 is used to find the combinations of item and location satisfying the user requested search criteria.

In these examples, item locator 320 functions as a generator capable of creating a query for the repository item database 310 on a storage device containing information for the location of the item, and as an extractor capable of obtaining a result from executing the query on a processor store server 302, the result including, for each item located, a location identifier, otherwise an indication of not found.

Item service 322 is a service application providing overall coordination of the received client request resolution. Item service 322 provides the necessary internal connections and interfaces to route request information to various system components responsible for their respective portion of the results and in similar manner, routing the response back through system components to the requester, may it be a user of kiosk 304, personal digital assistant 306, phone 308 or web client 311. Item service 322 also functions as a receiver capable of receiving a request for the location of the item and a notifier capable of returning the result to the requester. Notification may be processed through communications service 312 from either of short message service 314 or map builder 312.

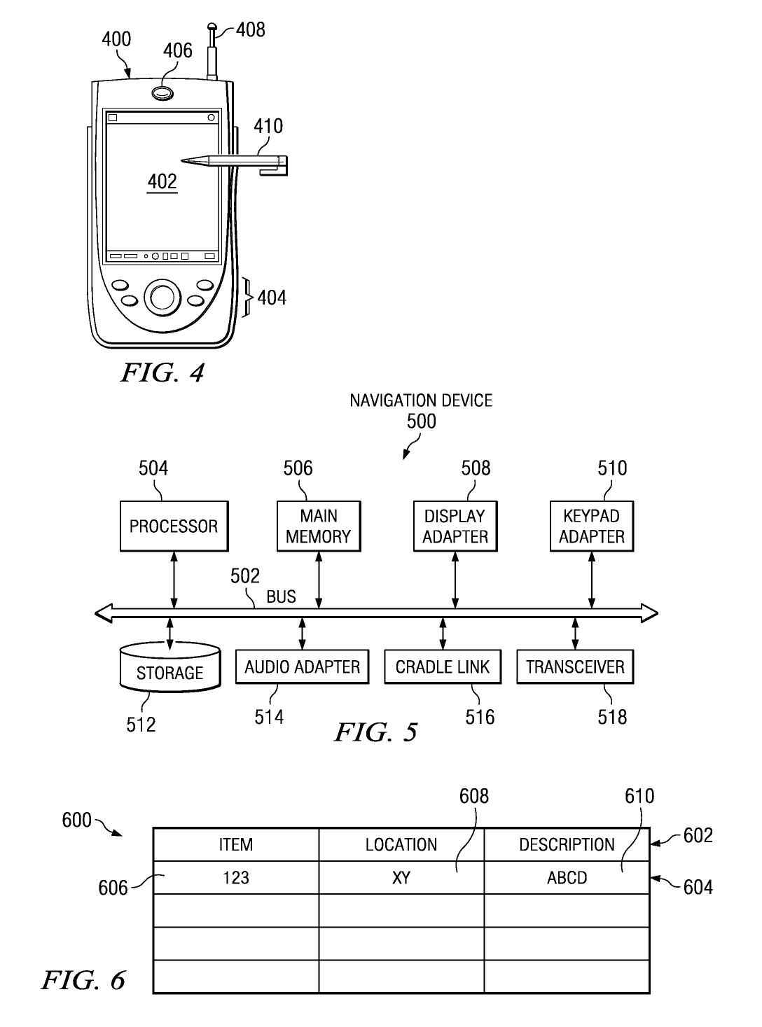

With reference to FIG. 4, a pictorial diagram of a client of FIG. 1 in accordance with illustrative embodiments is shown. For example, a client, such as client 110, in the form of a personal digital assistant (PDA) is depicted in accordance with illustrative embodiments. Personal digital assistant 400 includes a display 402 for presenting textual and graphical information. Display 402 may be a known display device, such as a liquid crystal display (LCD) device. The display may be used to present a map or directions, calendar information, a telephone directory, or an electronic mail message. Text messages in the form of short message system (SMS) may typically be viewed on display 402 and entered via keypad 404. In these examples, screen 402 may receive user input using an input device, for example, stylus 410.

Personal digital assistant 400 may also include keypad 404, speaker 406, and antenna 408. Keypad 404 may be used to receive user input in addition to using screen 402. Speaker 406 provides a mechanism for audio output, such as presentation of an audio file. Antenna 408 provides a mechanism used in establishing a wireless communications link between personal digital assistant 400 and a network, such as network 102 in FIG. 1.

Personal digital assistant 400 also preferably includes a graphical user interface that may be implemented by means of systems software residing in computer readable media in operation within personal digital assistant 400.

With reference to FIG. 5, a block diagram of the client of FIG. 4 in accordance with illustrative embodiments is shown. Personal digital assistant 500 is an example of a personal digital assistant, such as personal digital assistant 400 in FIG. 4, in which code or instructions implementing the processes of the present invention may be located. Personal digital assistant 500 includes a bus 502 to which processor 504 and main memory 506 are connected. Display adapter 508, keypad adapter 510, storage 512, audio adapter 514 and transceiver 518 also are connected to bus 502.

Cradle link 516 provides a mechanism to connect personal digital assistant 500 to a cradle used in synchronizing data in personal digital assistant 500 with another data processing system. Further, display adapter 508 also includes a mechanism to receive user input from a stylus when a touch screen display is employed. Transceiver 518 may be coupled to a telephone signal to provide full duplex communication. The telephone signal may be provided by a telephone line (not shown) in a land-based telephone or an antenna, such as for a wireless telephone. Audio adapter 514 provides basic analog audio outputs to speaker 406 and accepts analog audio inputs from a microphone (not shown). Received signals are demodulated and decoded by transceiver 518. Transceiver 518 encodes and modulates signals passed to it by processor 504 or audio adapter 514.

An operating system runs on processor 504 and is used to coordinate and provide control of various components within personal digital assistant 500 in FIG. 5. The operating system may be, for example, a commercially available operating system, such as Windows® CE, which is available from Microsoft® Corporation. Instructions for the operating system and applications or programs are located on storage devices, such as storage 512, and may be loaded into main memory 506 for execution by processor 504.

Those of ordinary skill in the art will appreciate that the hardware in FIG. 5 may vary depending on the implementation. Other internal hardware or peripheral devices, such as flash ROM (or equivalent nonvolatile memory) or optical disk drives and the like, may be used in addition to or in place of the hardware depicted in FIG. 5.

With reference to FIG. 6, a tabular diagram of a simple look-up table in accordance with illustrative embodiments is shown. In this example, table 600 is represented in a simple row and column format as may be implemented in a database scenario using database management system 318 and item database 310 of FIG. 3

Row 602 depicts header information comprising column names of item, location, and description. The item information may be stored in various formats in keeping with the teaching of the illustrative embodiments. A database representation as presented herewith is not intended to limit the scope of the information implementation. Extract interfaces will require knowledge of the information implementation. In the illustrative embodiments, database management system 318 provides the capability to store, retrieve, and manage the item's information.

Row 604 is representative of an entry comprising an item identifier 606, an item location 608, and an item description 610. Other data may be present including item cost and ordering or stock keeping information. In a very basic implementation, only a pair of fields containing item identifier 606 and item location 608 may be present. One skilled in the art would also recognize that the information just described, may otherwise be represented in the form of comma separated value pairs or even a single entry wherein item identifier 606 and item location 608 may be combined in a prefix or suffix relation.

Item identifier 606 may be any convenient sequence of characters that identifies a unit, category or collection of items. For example, item identifier 606 may be unique, as in the case of a person or specific article, or it may reflect a category such as fruit, or it may be a collection of similar items, such as brown shoes. In a similar manner, item location may be as coarse or fine grained as is needed to spatially reference the item. For example, a coarse grained instance may be used for an article found in a particular store aisle whereas a person located in a specific cubicle may be an example of a fine grained instance.

Depending upon the output device capability, presenting description along with an item location may be helpful to the recipient of the information as a confirmation. Additionally, the description need not be text, but could be in an audio or pictorial format.

In an illustrative embodiment, item identifier 606 may be used as a primary key, while item description 610 may be used as a secondary or alternate key when performing a search of item database 310 of FIG. 3.

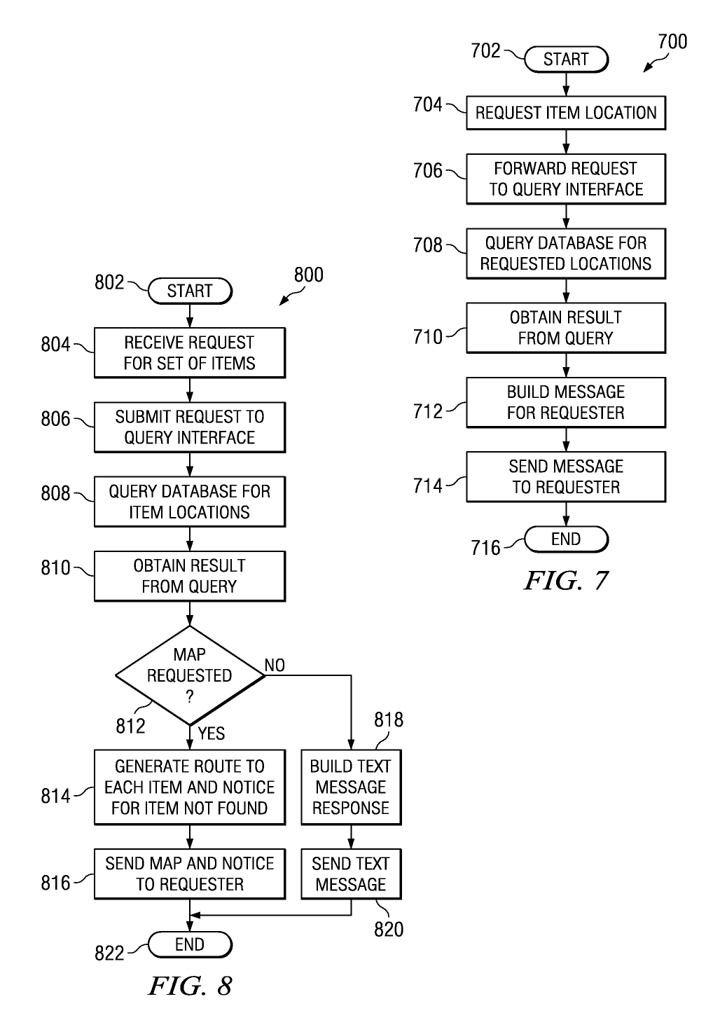

With reference to FIG. 7, a flowchart of a process requesting an item location in accordance with illustrative embodiments is shown. The high level flowchart of process 700 as implemented by item service 322 executing on store server 302 of FIG. 3 is one such illustrative embodiment. Process 700 starts (step 702) and receives a request for an item from a requester that may have been phone 308 (step 704). The request is forwarded by item service 322 to item locator 320 which is the query interface of database management system 318 (step 706).

Item locator 320 performs the requested query to obtain the location of the requested item using information maintained within the database (step 708). A query result is obtained and returned to item service 322 or if the output was destined for a short message service user, directly to short message service 314 (step 710).

A response is built including the found location information, or in the case when the item location could not be found, a message indicating “item not found” would be created (step 712). The response is built, by either item service 322 or short message service 314, as required. Having created a response, the response is sent to the requester using communication service 312 (step 714). Process 700 terminates thereafter (step 716).

With reference to FIG. 8, a flowchart of a process for a web based request for an item location in accordance with illustrative embodiments is shown. The high level flowchart of process 800 as implemented by item service 322 executing on store server 302 that interacts with a web client 311 of FIG. 3 is an example of one such illustrative embodiment. Process 800 starts (step 802) and receives a request for a set of items by item service 322 (step 804). The set of items typically includes more than one item, but may be for a single item. The received request is forward to the query interface of item locator 320 for querying of the item database 310 (step 806). Item locator 320 issues structured query language statements associated with the criteria of the received request to find the desired information with the database (step 808).

The set of item locations is determined and obtained or extracted using a database query (step 810). A determination is made if a map had been requested either explicitly or implicitly by default (step 812). If a map was requested for the set of items, (“yes” in step 812) then a map building operation is performed to generate a “best” route to each item in the set of items located (step 814). The map is then sent using communication service 312 of FIG. 3 to the requester (step 816). Process 800 terminates thereafter (step 822).

If no map was requested (“no” in step 812) a text response containing the set of items would be created (step 818). The creation of the text output would be performed by either item service 322 or short message service 314 of FIG. 3 as before. If a requested item could not be located a notification of “not found” or similar indication is created in both the map response and the text response. The response is then sent using either item service 322 or short message service 314 of FIG. 3 as before (step 820). Process 800 terminates thereafter (step 822).

Illustrative embodiments provide an effective service to resolve a request for an item location. Use of the exemplary service provides a requester with a time saving response to locate an item of interest whether the item is an article or an individual, within a spatial context, such as an office building or a store. While a database was used in the example, one skilled in the art would realize other practical repository choices would work. Short message services provide a capability to address a wide audience of users typically using wireless devices thereby expanding the applicability of the solution.

The invention can take the form of an entirely hardware embodiment, an entirely software embodiment, or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer readable recordable type medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for locating items, the computer implemented method comprising:
receiving a request for a location of an item from a requestor;
sending a query to a repository containing information relating to the location of the item;
obtaining a result from sending the query, wherein the result comprises a location identifier if the location of the item was found in the repository; and
returning the result to the requester.

2. The computer implemented method of claim 1 wherein receiving the request for the location of the item from the requestor comprises:
receiving the request for a set of items and corresponding locations.

3. The computer implemented method of claim 1 wherein sending a query to a repository containing information relating to the location of the item comprises:
creating a structured language query to be executed against the repository; and
sending the query to the repository.

4. The computer implemented method of claim 1 wherein returning the result further comprises:
creating one of a map and a set of text messages to form a response; and
sending the response to the requester.

5. The computer implemented method of claim 4 wherein the map indicates an optimal path to obtain each item located.

6. A data processing system for locating items, the data processing system comprising:
a bus;
a storage device connected to the bus;
a communications unit connected to the bus;
a processing unit connected to the bus;
a receiver capable of receiving a request for a location of an item from a requester;
a generator capable of sending a query to a repository containing information relating to the location of the item;
an extractor capable of obtaining a result from sending the query wherein, the result comprises, a location identifier, if the location of the item was found in the repository; and
a notifier capable of returning the result to the requester.

7. The data processing system of claim 6 wherein the receiver capable of receiving the request for the location of the item from the requester receives the request for a set of items and corresponding locations.

8. The data processing system of claim 6 wherein the generator capable of sending a query to a repository containing information relating to the location of the item comprises:
creating a structured language query to be executed against the repository; and
sending the query to the repository.

9. The data processing system of claim 6 wherein the notifier capable of returning the result further comprises:
creating one of a map and a set of text messages to form a response; and
sending the response to the requester.

10. The data processing system of claim 9 wherein creating one of a map and a set of text messages to form a response creates the map indicating an optimal path to obtain each item located.

11. A computer program product for locating items, comprising a computer usable recordable type medium having computer usable program code embodied thereon, the computer usable program code comprising:
computer usable program code for receiving a request for a location of an item;
computer usable program code for sending a query to a repository containing information relating to the location of the item;
computer usable program code for obtaining a result from sending the query, wherein the result comprises a location identifier, if the location of the item was found in the repository; and
computer usable program code for returning the result to the requester.

12. The computer program product of claim 11 wherein the computer usable program code for receiving the request for the location of the item from the requester comprises computer usable program code for receiving the request for a set of items and corresponding locations.

13. The computer program product of claim 11 wherein the computer usable program code for sending a query to a repository containing information relating to the location of the item comprises:
computer usable program code for creating a structured language query to be executed against the repository; and
sending the query to the repository.

14. The computer program product of claim 11 wherein the computer usable program code for returning the result further comprises:
computer usable program code for creating one of a map and a set of text messages to form a response; and
sending the response to the requester.

15. The computer program product of claim 14 wherein the map indicates an optimal path to obtain each item located.
